(19) United States
(12) Patent Application Publication
(10) Pub. No.: US 2004/0253406 A1
(43) Pub. Date: Dec. 16, 2004

(54) Vacuum heat insulating material and manufacturing method therefor

(75) Inventors: Masato Hayashi, Asahi-shi (JP); Hideto Sato, Asahi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 10/814,807

(22) Filed: Apr. 1, 2004

(30) Foreign Application Priority Data
Apr. 2, 2003 (JP) 2003-099552

(51) Int. Cl. B32B 1/04

(52) U.S. Cl. 428/69

(57) ABSTRACT

Provided is a vacuum heat insulating material, using inorganic fibers as a core material, high in heat insulating performance (low in thermal conductivity), capable of maintaining the heat insulating performance for a long period, free of defects such as projections and depressions on a large scale on a surface thereof, short in manufacturing time and advantageous in terms of cost; and a manufacturing method therefor. A vacuum heat insulating material of the present invention is of a construction in which a core material 1 and a gas adsorbent 2 are housed in a bag 3 made from a gas barrier film and the interior thereof is reduced in internal pressure thereof and air-tightly sealed, wherein the core material 1 is a molded product obtained by coating a binder B on inorganic fibers having an average fiber diameter in the range of from 3 to 5 μm at a coating amount in the range of from 0.5 to 1.5 wt % relative to the fibers and heat pressing the inorganic fibers, or a laminate fabricated by stacking two or more sheets of the molded product.

### BACKGROUND OF THE INVENTION

1. Field of the Invention

The present invention relates to a vacuum heat insulating material using inorganic fibers as a core material thereof and a manufacturing method therefor.

2. Description of the Background Art

Materials including polyurethane foam, inorganic fibers, inorganic powder and the like have been used as a core material of a vacuum heat insulating material that is housed in a bag made from a gas barrier film, the interior of which is reduced in internal pressure thereof and air-tightly sealed, and it has been conventionally known that by using, among the materials, inorganic fibers as a core material, it enables low thermal conductivity (high heat insulating performance) of about 0.0025 W/mk to be achieved.

In a case where inorganic fibers are inserted into a bag without receiving a pretreatment, followed by deaeration under a reduced pressure, a problem has arisen that operability in this case is poor and a density of inorganic fibers has to be raised in order to keep smoothness of a surface of a vacuum heat insulating material. Part of the inorganic fibers is scattered out onto an air-tight seal portion of the opening of the bag, in which case the seal after air-tight sealing under a reduced pressure is insufficient, also having resulted in another problem of obtaining a product without a predetermined performance.

Therefore, in order to solve the problems, it is necessary to solidify the inorganic fibers into a sheet, whereas if the core material is molded simply with an organic binder into a sheet, this process has led to another problem that an outgased volatile comes out of the core material over time and a heat insulating performance is degraded over time. An inorganic binder can replace the organic binder to mold the core material with the inorganic binder into a sheet, whereas, in this case, a still another problem has arisen that the sheet has no elasticity, cracking occurs in gas discharge under a reduced pressure and it takes a long time for the gas discharge under a reduced pressure due to formation of a film from the inorganic binder.

Description will be given of the problems using concrete examples and in Patent literature 1 (JP-A No. 5-87292), there is described a manufacturing method for a vacuum heat insulating wall in which an heat insulating mat made from inorganic fibers being mixed with an organic binder to then be compression hardened down to a thickness almost equal to that of a heat insulating space of an heat insulating wall is inserted into the heat insulating space and thereafter, the heat insulating mat is heated up to a decomposition temperature of the organic binder in the presence of air to gasify the organic binder for removal, followed by vacuum gas discharge from the heat insulating space. In Patent literature 2 (JP-A No. 7-139691), there is described a vacuum heat insulating material manufactured by a procedure in which plural paper sheets made in acidic paper making with inorganic fibers are stacked into a laminate and the inorganic fibers are bonded to each other at intersection of the fibers with an eluded component from the fibers. In Patent literature 3 (JP-A No. 7-167376), there is described a vacuum heat insulating material manufactured in a procedure in which inorganic fibers are aggregated, attached with an acidic aqueous solution, and then dehydrated and dried; and an eluded component from the fibers are collected at intersections between the fibers and hardened there to thereby bond the fibers to each other at intersections of the fibers with the eluded component from the fibers. Then, in Patent literature 4 (JP-A No. 2002-310384), there is described a vacuum heat insulating material including a core material manufactured by stacking a reinforcing material on at least one surface of an inorganic fiber aggregate made from very fine inorganic fibers and an outer coat material having a gas barrier property without containing a bonding agent for solidifying a fiber material in the inorganic fiber aggregate.

Even if the organic binder is tried so as to be heat decomposed as described in Patent literature 1, a problem has arisen that the whole of the organic binder is hard to be removed, for which it takes a very long time, and the cost is increased. The acidic treatment as described in Patent literature 2 or 3 requires large scale facilities including equipment for a neutralization step after the acidic treatment and a drying step and what's worse, an insulating performance is at a risk to be degraded because of thermal conduction in a melt portion. Then, if a reinforcing material is used as described in Patent literature 4, a warpage occurs due to a difference in strength between the inorganic fiber aggregate and the reinforcing material and in addition, an insulating performance of the reinforcing material has a great influence; therefore a possibility arises that deteriorates an insulating performance of the inorganic fibers themselves.

### SUMMARY OF THE INVENTION

The present invention has been made in light of the problems in conventional vacuum heat insulating materials using inorganic fibers in a core material and it is an object of the present invention to provide a vacuum heat insulating material, using inorganic fibers as a core material, high in heat insulating performance (low in thermal conductivity), capable of maintaining the heat insulating performance for a long period, free of defects such as projections and depressions on a large scale on a surface thereof, short in manufacturing time and advantageous in terms of cost; and a manufacturing method therefor.

A vacuum heat insulating material of the present invention provided for the purpose to solve the above problems is such that a core material and a gas adsorbent are housed in a bag made from a gas barrier film and the interior thereof is reduced in internal pressure thereof and air-tightly sealed, wherein the core material is a molded product obtained by coating a binder on inorganic fibers having an average fiber diameter in the range of from 3 to 5 μm at a coating amount in the range of from 0.5 to 1.5 wt % relative to the fibers and heat pressing the inorganic fibers, or a laminate fabricated by stacking two or more sheets of the molded product.

In the present invention, inorganic fibers that can be used in the above construction are one or more kinds selected from the group consisting of glass fibers, ceramic fibers, rock wool, silica alumina wool and a binder that can be used therein is one or more selected from the group consisting of phenol resin, NBR rubber modified high ortho-phenol resin, NBR rubber modified phenol resin, melamine resin, epoxy resin, NBR, nitrile rubber, acrylic rubber, silica alumina and the like.

A manufacturing method for a vacuum heat insulating material of the present invention that has been made for the purpose to solve the above problems is such that a binder is coated on inorganic fibers having an average fiber diameter in the range of from 3 to 5 μm at a coating amount in the range of from 0.5 to 1.5 wt % relative to the fibers, a core material made of a molded product obtained by pressure-molding the inorganic fibers while being heated or a core material fabricated by stacking two or more sheets of the molded product together with a gas adsorbent is housed in a bag made from a gas barrier film, and the interior of the bag is reduced in internal pressure thereof, followed by air-tight sealing of an opening thereof. Note that the opening can also air-tightly sealed by a double heat seal.

The inventors of the present invention have conducted serious studies for the purpose to achieve the object with the result acknowledged by the inventors that adopted as a core material is a molded product obtained by coating a trace of a binder (a resin) on inorganic fibers to then mold the fibers by heat pressing or a laminate obtained by stacking two or more sheets of the molded product, whereby the problems are solved, leading to completion of the present invention.

### BRIEF DESCRIPTION OF THE DRAWINGS

FIG. 1 is a sectional view of an example of vacuum heat insulating material of the present invention.

FIG. 2 is a sectional view of another example of vacuum heat insulating material of the present invention.

FIG. 3 is a conceptional view showing an example of manufacturing method for the vacuum heat insulating material of FIG. 1 in a chronological order.

### DESCRIPTION OF THE PREFERRED EMBODIMENT

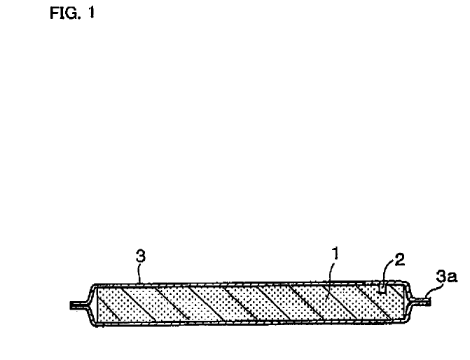

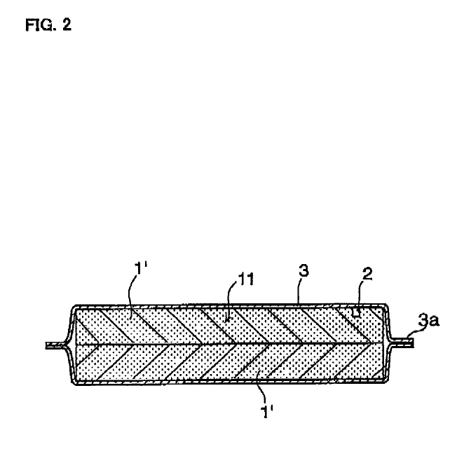

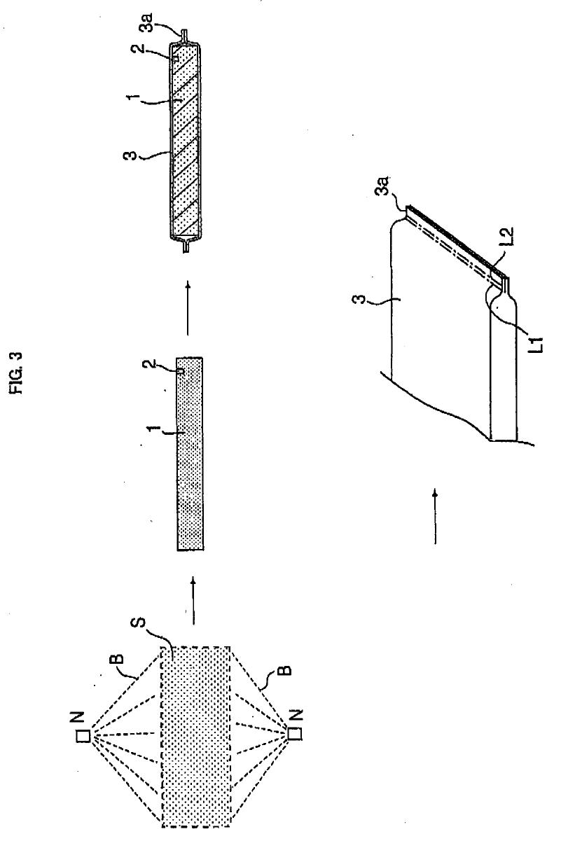

Description will be given of examples of an embodiment with reference to the accompanying drawings. FIG. 1 is a sectional view of an example of vacuum heat insulating material of the present invention, FIG. 2 is a sectional view of another example of vacuum heat insulating material of the present invent-ion and FIG. 3 is a conceptional view showing an example of manufacturing method for the vacuum heat insulating material of FIG. 1 in a chronological order.

A vacuum heat insulating material of the present invention is of a construction in which as shown in FIG. 1, a core material 1, together with a gas adsorbent 2, obtained by applying predetermined molding to inorganic fibers, is housed in a bag 3 made from a gas barrier film and the interior of the bag 3 is reduced in internal pressure thereof and then an opening 3a is air-tightly sealed, or alternatively, of a construction in which as shown in FIG. 2, a core material 11 made by stacking two sheets of a molded product 1′ formed by applying predetermined molding to inorganic fibers, together with a gas adsorbent 2, is housed in a bag 3 made from a gas barrier film and then the interior of the bag 3 is reduced in internal pressure thereof and an opening 3a is air-tightly sealed. Note that a laminate obtained by stacking three or more sheets of the molded product 1′ may be used as a core material. Herein, examples of kinds of inorganic fibers include glass fibers, ceramic fibers, rock wool, silica alumina wool and the like, which may be in a single kind or in proper combination of different kinds.

Inorganic fibers are used in a state after being coated with a resin (a binder B), followed by thermomolding. Examples of resins as the binder B include phenol resin, NBR rubber modified high ortho-phenol resin, NBR rubber modified phenol resin, melamine resin, epoxy resin, NBR, nitrile rubber, acrylic rubber, silica alumina and the like, among which preferable is phenol resin and more preferably phenol resin used alone without being added with urea.

A coating amount of a binder B described above is generally in the range of from 0.5 to 1.5 wt % and preferably in the range of 0.75 to 1.25 wt % relative to the mass of inorganic fibers. If the coating amount is in that range, a resin amount on the surface layers of the inorganic fibers that tends to be hardened in press molding can be reduced which makes it possible to reduce a solid layer that is a cause for a long pressure reduction time and to reduce a thickness of a predetermined thickness of the inorganic fibers and facilitate handling, thereby enabling the object of the present invention to be achieved.

A density of the inorganic fibers (core material 1) after compression is preferably in the range of from 150 kg/m³ to 250 kg/m³. If the density is in that range, a heat insulating performance is held in a high state. A thickness of the core material is generally in the range of 10 to 50 mm and preferably in the range of from 10 to 15 mm as a set value and a thickness after restoration is desirably in the range of from 30 to 50 mm. Within the range, no problem occurs in handlability.

Examples of gas barrier films from each of which a bag 3 is made include a laminated film of a metal foil and a plastic film (a metal foil film), a film obtained by stacking a vapor deposited film instead of a metal foil and a plastic film (a vapor deposited layer film) and the like.

Used as a metal foil is an aluminum foil, stainless foil or the like, and used as a material of a vapor deposited layer of a vapor deposited layer film is aluminum, stainless or the like. Used as material of a plastic film is polyethylene terephthalate, Nylon, a low-density polyethylene, high-density polyethylene, polypropylene or the like.

Named as examples of gas barrier films are a laminate film with a four layer structure of polyethylene terephthalate film/Nylon film/aluminum foil/polyethylene film, a laminate film with a three layer structure of polyethylene terephthalate film/aluminum foil/high-density polyethylene film and the like.

In a case where each of the films are processed into a bag 3, the bag 3 is formed so as to have the polyethylene film inside the bag. It is naturally possible to use vapor deposited layer films obtained by adopting a vapor deposited film instead of the aluminum foil in the laminate films. It is also possible to use a composite film obtained by adhering a metal foil film on the surface of the vapor deposited film with a hot melt adhesive.

The gas adsorbent 2, together with the core material 1, is housed in the bag 3. The gas adsorbent 2 works so as to adsorb an outgased volatile generating from the core material 1 with time. Examples thereof include calcium oxide, active charcoal, silica gel, molecular sieve, zeolite and others, which are used either alone or in combination of two or more kinds.

Then, description will be given of a manufacturing method for a vacuum heat insulating material of the present invention with reference to FIG. 3. At first, a binder B is coated on inorganic fibers S before being molded into a core material 1. As coating methods, there have been available a method in which the binder B is coated by spraying it onto circumferential surfaces thereof the inorganic fibers in process, an impregnation method and the like. Among the methods, preferable is coating by means of spraying. An reference mark N indicates a nozzle for spraying, from which the binder B is coated uniformly on surfaces of the inorganic fibers S. A coating amount is generally in the range of from 0.5 to 1.5 wt % and preferably in the range of from 0.74 to 1.25 wt % relative to the inorganic fibers S. The binder B is diluted with a solvent when being coated. Water, a thinner or the like is properly used as a diluent solvent.

A heat press machine (not shown) may be of a general purpose type that has been commonly employed in a press operation. The inorganic fibers S subjected to the processing by the machine are molded in conditions of a pressure in the range of 10 to 10000 g/cm² and a temperature in the range of from 100 to 300° C. to a set thickness in the range of from 10 to 50 mm. While a molding time may be properly set so that a thickness of the inorganic fibers after restoration falls within the range from 30 to 50 mm to thereby facilitate handling thereof, the time in the range of from 1 to 5 minutes is preferable in terms of a balance between moldability and operability.

The core material 1 obtained by molding as described above, together with a gas adsorbent 2, is housed in the bag 3 made from a gas barrier film, then the interior thereof is reduced in internal pressure thereof and the opening 3a is sealed air-tightly to obtain the vacuum heat insulating material. Note that while air-tight seal of the opening 3a is generally heat seal, it is desirable in the present invention to heat seal the opening 3a doubly in consideration of air-tightness thereof. Reference marks L1 and L2 show a double line of heat seal applied in the opening 3a. If air-tightness of a bag is sufficient in a single line of heat seal, the heat seal may be even of a single line.

In a case where the core material 11 is a laminate type of the molded products 1′ and 1′ as shown in FIG. 2, a set thickness of the inorganic fibers S of which the molded product 1′ is made in conditions of a pressure and a predetermined temperature of a heat press machine is set properly so as to be adapted for a use condition of a vacuum heat insulating material to be manufactured.

### EXAMPLE

Then, vacuum heat insulating materials of the present invention each using one sheet of a molded product shown in FIG. 1 as a core material, in each of which glass fibers were used as inorganic fibers, phenol resin alone was used as a binder without adding urea, and vacuum heat insulating materials each manufactured by using a composite film of an aluminum foil and a plastic film as a gas barrier film for a bag were subjected to evaluation tests with respect to the following parameters (1) to (5).

(1) Thermal Conductivity

Vacuum heat insulating materials were manufactured changing a coating amount of a binder applied onto inorganic fibers serving as a core material, followed by a high temperature aging test. A size of each vacuum heat insulating material is 10×300×300 (mm). Thermal conductivity values are as shown in Table 1 shown below.

TABLE 1
High temperature aging test for heat insulating
materials

Thermal conductivity (W/m · K)

| Binder coating | Initial | | | |
|---|---|---|---|---|
| amounts (wt %) | values | 7 days | 30 days | 50 days |
| None | 0.00207 | 0.00248 | 0.00253 | 0.00376 |
| 0.5 | 0.00207 | 0.00249 | 0.00299 | 0.00404 |
| 1.0 | 0.00210 | 0.00249 | 0.00334 | 0.00445 |
| 1.5 | 0.00220 | 0.00251 | 0.00342 | 0.00461 |
| 3.0 | 0.00289 | 0.00331 | 0.00430 | 0.00578 |
| 10.0 | 0.00378 | 0.00812 | 0.01182 | 0.01671 |

*the aging temperature: 70° C.
*gas adsorbent: COMBO-B one piece (manufactured by Saes Co.)

As clearly shown on the above Table 1, it is recognizable that the vacuum heat insulating materials with a coating amount, 0.5, 1.0 and 1.5 wt % within the range of a binder coating amount (from 0.5 to 1.5 wt %) in the present invention show a low thermal conductivity of same degree as the thermal conductivity of the vacuum heat insulating materials without having any binder coating and can maintain it for a long period.

In contrast to this, the vacuum heat insulating materials with binder coating amounts of 3.0 and 10.0 wt % has high thermal conductivity and especially the vacuum heat insulating material with the binder coating material of 10.0 wt % is conspicuous in degradation in thermal conductivity over a long period of use.

In the present invention, there is adopted a phenol resin binder of a new type in which no urea is added to a phenol resin and the phenol resin is used alone, which is different from a phenol resin binder of a conventional type added with urea that has thus far been used commonly for molding glass fibers; therefore, it can be said that such a change reduces excessive outgasing, which results in a low thermal conductivity.

In the present invention, since a binder coating amount is reduced, the surface layers of the inorganic fibers are not hardened. In evacuation, it is further possible to decrease a solid layer working as a resistance against it.

Then, the vacuum heat insulating materials were subjected to the following evaluations including a parameter in a manufacturing stage.

(2) Surface Profile

⊚: flat

◯: protrusions and depressions on small scale

X: protrusions and depressions on large scale

(3) Handlability of Core Material

⊚: easily handlable with one hand

◯: handlable with one hand or both hands

X: with a need for handling tool

(4) Insertability into Bag

⊚: easily insertable into packaging bag

◯: hard to be inserted into bag, though without a tool

X: hard to be inserted into bag even with a tool

(5) Thermal Conductivity

⊚: lower than 0.0023 W/m·K

◯: equal to or higher than 0.0023 and lower than 0.0028

Δ: equal to or higher than 0.0028 and lower than 0.0033

X: higher than 0.0033

In Table 2 shown below, there are presented results of the evaluations.

TABLE 2

| | surface | | | | |
|---|---|---|---|---|---|
| Binder | profiles of | hand- | | Thermal con- | |
| Coating | vacuum | ability | Insert- | ductivity (W/m · K) | |
| amounts | heating | of core | ability | Initial | |
| (Wt %) | materials | materials | into bag | values | Evaluations |
| Open-cell PUF | ⊚ | ⊚ | ⊚ | 0.00412 | X |
| none | X | X | X | 0.00207 | ⊚ |
| 0.5 | ◯ | ◯ | ◯ | 0.00207 | ⊚ |
| 1.0 | ◯ | ◯ | ◯ | 0.00210 | ⊚ |
| 1.5 | ◯ | ◯ | ◯ | 0.00220 | ⊚ |
| 3.0 | ◯ | ◯ | ◯ | 0.00289 | Δ |
| 10.0 | ⊚ | ⊚ | ⊚ | 0.00378 | X |

As clearly shown on the above table 2, in view of the above points (2) to (5), it is recognizable that the vacuum heat insulating materials with a coating amount, 0.5, 1.0 and 1.5 wt % within the range of a binder coating amount (from 0.5 to 1.5 wt %) in the present invention and the vacuum heat insulating materials without having any binder coating are at same degree in heat insulating performance (thermal conductivity), whereas the first ones are superior to the second ones in terms of surface profile, handlability of a core material and insertability into a bag. Further, the vacuum heat insulating materials in the present invention are equal to the vacuum heat insulating materials with binder coating amounts of 3.0 and 10.0 wt % and the vacuum heat insulating material made of open-cell foamed PUF (polyurethane foam), whereas the first ones are more profitable than the second and third ones in point of heat insulating performance.

As described above, since a vacuum heat insulating material of the present invention adopts a molded product, as a core material, obtained by coating a trace of a binder resin on surfaces of inorganic fibers to mold the fibers by heat pressing, the following effects can be obtained: heat insulating performance is high, the heat insulating performance can be maintained for a long period and further, there arise no defects such as protrusions and depressions on a large scale on the surface. In addition, a manufacturing time is shorter and a manufacturing cost can also be lower.

Since a vacuum heat insulating material of the present invention is high in heat insulating performance (low in thermal conductivity) as described above, it has the effect of being used widely in various kinds of applications such as a note book personal computer, an oven range, an electric water boiler, a refrigerator, a freezing chamber, a refrigerated vehicle, a freezing container, a cooler box and the like.

What is claimed is:

1. A vacuum heat insulating material with a construction in which a core material and a gas adsorbent are housed in a bag made from a gas barrier film and the interior thereof is reduced in internal pressure thereof and air-tightly sealed, wherein the core material is a molded product obtained by coating a binder on inorganic fibers having an average fiber diameter in the range of from 3 to 5 μm at a coating amount in the range of from 0.5 to 1.5 wt % relative to the fibers and heat pressing the inorganic fibers, or a laminate fabricated by stacking two or more sheets of the molded product.

2. The vacuum heat insulating material according to claim 1, wherein the inorganic fibers are one or more kinds selected from the group consisting of glass fibers, ceramic fibers, rock wool, silica alumina wool.

3. The vacuum heat insulating material according to claim 1 and 2, wherein the binder is one or more selected from the group consisting of phenol resin, NBR rubber modified high ortho-phenol resin, NBR rubber modified phenol resin, melamine resin, epoxy resin, NBR, nitrile rubber, acrylic rubber, silica alumina and the like.

4. A manufacturing method for a vacuum heat insulating material in which a binder is coated on inorganic fibers having an average fiber diameter in the range of from 3 to 5 μm at a coating amount in the range of from 0.5 to 1.5 wt % relative to the fibers, a core material made of a molded product obtained by pressure-molding the inorganic fibers while being heated or a core material fabricated by stacking two or more sheets of the molded product together with a gas adsorbent is housed in a bag made from a gas barrier film, and the interior of the bag is reduced in internal pressure thereof, followed by air-tight sealing of an opening thereof.

5. The manufacturing method for a vacuum heat insulating material according to claim 4, wherein the opening is air-tightly sealed by a double heat seal.
